(19) United States
(12) Patent Application Publication
(10) Pub. No.: US 2025/0282519 A1
(43) Pub. Date: Sep. 11, 2025

(54) MODIFIED RECYCLABLE CONTAINER AND METHOD OF FORMING A SHIPPING PACK HAVING ARTICLES SECURED THEREIN

(71) Applicant: Andrew Whiteside, Bungay (GB)

(72) Inventor: Andrew Whiteside, Bungay (GB)

(21) Appl. No.: 19/075,622

(22) Filed: Mar. 10, 2025

(30) Foreign Application Priority Data
Mar. 11, 2024 (GB) 2403520.6

(51) Int. Cl. B65D 5/56; B65B 5/02; B65B 43/10

(52) U.S. Cl. CPC B65D 5/566; B65B 5/024; B65B 43/10

(57) ABSTRACT

A modified container and blank therefore of the RSC type having a material web attached thereto to retain an article within an erected container. The web material is selected from one or more materials having substantially identical recycling characteristics to the container material and is coated in a cohesive film. Two operably oppositely disposed lid portions of the container include a slot centrally formed therein so as to facilitate the deflection inwardly of the web material to overlie in a predetermined configuration articles to be secured within a shipping pack thus formed. Methods of deflecting the web and sealingly securing articles to be retained within the shipping pack are disclosed.

### FIELD OF THE INVENTION

The present invention relates to a container for forming a shipping pack and a blank therefor. The invention further relates to a method of securing articles within a shipping pack.

The invention relates particularly to the packaging of single or multiple upright or irregularly shaped articles such as beverage, condiment or shampoo and shower gel bottles, machine parts and vehicles spares.

More generally, the invention is directed to the packaging of non-flat articles for which there are numerous specifically designed containers, for example, for books or video cassettes and discs, such as CDs and DVDs. The invention also relates to a shipping pack (that is, including packaged articles) formed using the container and method of the invention.

The invention particularly relates to a method of ensuring articles placed within a shipping pack formed using the container are retained therein without damage-causing movement.

The invention additionally relates to a container blank made of card and cardboard or similar material, the blank being adapted to include an article retaining material web to secure articles and prevent damage-causing movement within the container formed from the blank. The invention is described hereinbelow with reference to non-flat articles such as those exemplified above, however it should be appreciated that no such limitation exists.

It will be appreciated by the skilled addressee that the invention, although directed towards the packaging of upright or irregularly shaped articles, may be applied to any three-dimensional object locatable within the container and is not limited to similarly shaped articles such as beverage or condiment bottles. The invention may also be used for the packaging and shipping of stacks of flat articles such as books and DVDs.

### BACKGROUND TO THE INVENTION

Increasingly, customers are eschewing the time-consuming routine of travelling to purchase their shopping and/or personal and business requisites. It is now common for purchases to be made by mail order, telephone and via the Internet and email. As a consequence, for goods to be received there is a marked increase in the use of postal and courier services to deliver the purchases.

The further involvement of postal services and other delivery systems is different from the traditional mode of shopping where the customer travels to purchase articles over the counter and returns using public or their own transport means. In this scenario, packing or packaging is done at the counter or before the customer leaves, after which responsibility for damage no longer resides with the seller. As most postal and courier services either limit their liability for damage to articles delivered by them or charge significant premiums for insurance against such damage, it falls to the retailer, warehouseman or company dispatching the purchase to ensure there is minimal risk of damage during transit to the customer. The term “postal” as used herein is intended as a convenient expression of all local, national and international dispatch, delivery and courier services, including drop-shipping services and the terms “dispatch”, “delivery” and “shipping” and their derivatives are used interchangeably.

With the increased popularity of Internet shopping and the dispatch of ordered articles via the postal system the requirement for packaging has increased manyfold. The popularity of such websites as Amazon™ and eBay™ have increased the postal traffic of books, CDs, CDROMs and DVDs amongst others. Also, with costs associated with deliveries, many machine parts and vehicle spares, including bulky and awkwardly shaped items, such as vehicle light clusters, are dispatched via courier rather than parts providers running their own delivery service, as was common in the past. Due to the vast turnover of dispatched articles and the inherent risks associated with the bulk handling of goods, there is a market requirement for sturdy containers. Additionally, as the volume of mail order catalogue business increases so too does the volume of returns. This has a severe consequence on the profitability of the mail order transaction and, where the returned article is damaged, the customer must bear responsibility for the damage. This condition of sale often has repercussions for customer relationships.

In other words, a fundamental requirement of any method of goods transportation is that the goods are not damaged during transport so that they reach their destinations in a non-damaged state.

It has been found in practice, that the packaging of articles such as bottles, machine parts and vehicle spares and similar articles having at least one dimension substantially greater than the others has presented, in terms of packaging, a significant ongoing problem. This problem manifests itself particularly in situations where the articles are packaged on a production line basis using a packaging method involving the folding of a cardboard-like blank into a container for receiving an article to be packed.

Containers formed from blanks made of card and cardboard and other materials suitable for dispatch through the postal services are well known in the prior art. Generally, the containers are formed from a relatively simple blank having multiple cut-aways to define a blank having side walls separated by fold lines and one or more base and lid portions connected to one or more of the side walls by corresponding fold lines. Commonly, to construct the container, an end tab of one side wall is secured to an edge portion of another side wall and the or each base portion is folded and secured to form an open-mouthed container. When the or each article to be dispatched has been placed within the container, the or each lid portion is folded and secured. The means of securing the portions to form the container is normally selected from gluing, stapling or applying adhesive tape. RSC type containers are typical of those in common use.

It will be appreciated that unless the container is designed to receive the specific article(s) to be dispatched, further packaging materials will be required to prevent the article(s) moving about within the container. In the packaging industry generally, there is a move to obviate extraneous packaging materials and, in some countries, there are regulations and legislation to prevent wasteful packaging practices.

The invention is directed to overcoming some of the established disadvantages associated with prior art containers, particularly those realising a container which is adapted for encapsulating or otherwise securing one or more articles within the container to prevent damage due to movement within the container during transit to its destination.

In an attempt to obviate some of the disadvantages highlighted above, a solution suggested in the prior art is to utilise a web of lining material to secure the articles within the container.

One established solution is to place the articles for dispatch in a tray, usually of a cardboard material. The tray and articles are then wrapped by a web of plastics material which is subsequently heated to effect a shrink-wrapped package. Alternatively, the web or film is tensioned around the article(s) by folding elements of the tray to which the web is attached. This package is then placed into a pre-formed container which is finally sealed and marked for dispatch. This arrangement, however, has its own disadvantages including that, although the articles are bound together, the tray will often move sufficiently in the container to dislodge the articles from the tray. Furthermore, this arrangement does not avoid the use of unnecessary additional packaging materials and includes an extra stage in the packaging process.

Consequently, there is a perceived need to provide a container having an article retaining means which is adaptable to conform with the article or articles contained therein to minimise movement of the or each article within the container during transit.

In another solution, United Kingdom Patent No. GB 2 343 885 describes a container blank to which a sheet or web of lining material is secured. This lining material is shrink-wrappable so that articles may be placed directly into the container and secured in situ.

There has been an increasing awareness for the need for packaging to be easily recyclable and, although the general public are increasingly involved in the separation of recyclable and non-recyclable waste, where there is separation of materials required it is perceived as being simpler simply to discard the entire packaging for processing as non-recyclable waste. More recently, packaging legislation has pushed packaging manufacturers towards simpler and less obtrusive packaging use to cut down the volume of packaging material that is used for individual containers.

U.S. Pat. No. 9,340,317 describes a container blank of the RSC type having a material web attached thereto to retain an article within a container formed from the blank. The web material is selected from one or more materials having substantially identical recycling characteristics to the material from which the blank is formed. The web material is coated with a cohesive film and can be stacked and handled without tack.

It is an object of the present invention to seek to alleviate the established disadvantages of the prior art and to seek to provide a container and blank therefor which facilitates the securing of articles in a shipping pack formed therefrom.

It is a particular object of the present invention to provide a method of securing articles in a lined open-mouthed shipping pack prior to closing and sealing.

It is an additional object of the present invention to provide a method of manipulating an article-retaining web lining a container to constrain at least one article therein for dispatch or storage.

### SUMMARY OF THE INVENTION

In its primary aspect, the present invention provides a container lined with a material web, the container comprising:
a series of four segments, each having a side wall portion to which there is attached, along respective fold lines, a base element and a lid element, the segments being joined to at least one other segment by a side wall fold line,
the material web adapted to line the container being secured to each side wall adjacent the respective base element fold lines and being sufficient in height to protrude from outer edges of the lid elements when the container is in an open-mouthed-configuration,
in which at least two lid elements have defined therein an access aperture centrally disposed on and extending from the outer edge thereof towards its fold line

whereby adhesive carrying portions of the material web are engaged to overlie one another and compacted to adhere to one another intimately against the or each article to secure said articles therewithin.

Advantageously, the access aperture is defined by a semi-circular aperture cut from the outer edge of the selected lid elements.

Optionally, the access aperture is defined by a slot extending from the outer edge of the selected lid elements at least one half way towards the lid element fold line.

The present invention also provides a container blank for forming the container defined hereinabove configured as a flat stackable blank.

Conveniently, the container blank comprises a series of four segments, each having a side wall portion to which there is attached, along respective fold lines, a base element and a lid element, the segments being joined to at least one other segment by a side wall fold line wherein a material web extends over at least a part of each of the segments and defines the inner surface of the container formed from the blank.

Ideally, the material web is secured to the segments along a region adjacent the base element fold lines.

Advantageously, the material web is presented so that articles to be retained within the container are placed within the base portion and the material web is then closed and tensioned to secure each article therein.

Preferably the material web has cohesive portions thereon, the portions being brought together so that the cohesive regions bond across their entire free area until the bonded section abuts the upper surface of the or each article held therein, thereby creating the constraining tension to the article(s).

Conveniently, the cohesive portion includes an adhesive adapted to adhere only to surfaces having like adhesive thereon.

Advantageously, the cohesive portions are spray coated with a cold-seal adhesive.

In a preferred construction of the container blank, an RSC type container blank has secured thereto a web of material over at least part of the side wall forming regions and extending over at least a major part of the lid forming regions.

In another aspect, the present invention discloses an apparatus for conforming a material web of a lined container as defined hereinabove to retain an article within the container to form a shipping pack, the container being presented in an open-mouthed configuration within which one or more articles for shipping have been placed on the base thereof, the outer edges of the lid elements being presented as pairs of parallel and perpendicular edges aligned with their respective side walls, the apparatus comprising:
an inlet feed, defining a feed direction from which filled lined containers are released in timed sequence along a conveyor;
a first folding station where lid elements disposed parallel to the feed direction are deflected outwardly and material folding fingers penetrate the access apertures of each lid element disposed perpendicularly to the feed direction, deflecting the material web inwardly over the or each article therewithin and conforming the material web in a predetermined folding pattern whereby portions of the material web corresponding to the deflected lid elements are angled inwardly;
a second folding station positioned downstream in the feed direction to which the container is conveyed, where the outwardly deflected lid elements are guided under retaining plates over which sequentially a first side folding mechanism and a second folding mechanism convey the exposed material web into a folded pattern over the or each article and apply a minor tamping force to the folded web material;

a compression station to which the container is conveyed from said second station where a conformable pad penetrates the open-mouthed container and is pressed downwardly with a force exceeding that of the tamping force onto the folded material web to conform the material web intimately around the or each article and to activate the adhesive on the adhesive carrying portions of the web so as to retain the or each article within the container; and

an outlet where the open-mouthed container with secured articles therein is conveyed to further apparatus or directly connected stations for folding and sealing of the lid elements to form a sealed shipping pack.

In further aspect, the present invention provides a method of conforming a material web of a lined container of the described hereinabove to retain an article within the container to form a shipping pack, the container being presented in an open-mouthed configuration within which one or more articles for shipping have been placed on the base thereof, the outer edges of the lid elements being presented as pairs of parallel and perpendicular edges aligned with their respective side walls, the method comprising:
releasing in timed sequence along a conveyor at an inlet feed, which defining a feed direction, filled lined containers;
at a first folding station deflecting outwardly lid elements disposed parallel to the feed direction, penetrating the access apertures of each lid element disposed perpendicularly to the feed direction with material folding fingers to deflect inwardly the material web over the or each article and conforming the material web in a predetermined folding pattern whereby portions of the material web corresponding to the deflected lid elements are angled inwardly;
a second folding station positioned downstream in the feed direction to which the container is conveyed, where the outwardly deflected lid elements are guided under retaining plates over which sequentially a first side folding mechanism and a second folding mechanism convey the exposed material web into a folded pattern over the or each article and apply a minor tamping force to the folded web material;
a compression station to which the container is conveyed from said second station where a conformable pad penetrates the open-mouthed container and is pressed downwardly with a force exceeding that of the tamping force onto the folded material web to conform the material web intimately around the or each article and to activate the adhesive on the adhesive carrying portions of the web so as to retain the or each article within the container; and
an outlet where the open-mouthed container with secured articles therein is conveyed to further apparatus or directly connected stations for folding and sealing of the lid elements to form a sealed shipping pack.

### BRIEF DESCRIPTION OF THE DRAWINGS

The invention will now be described more particularly with reference to the accompanying drawings which show, by way of example only, an embodiment of modified container and details of an apparatus for effecting a method of securing articles for shipping within the container. In the drawings:

FIG. 1 is a perspective view of a standard RSC container of the prior art having a cohesive web of material provided thereon;

FIG. 2 is a schematic perspective elevation of an apparatus illustrating a modified container and method in accordance with the invention;

FIG. 3 is an exposed perspective view of the apparatus of the invention comprising upper and lower assemblies;

FIGS. 4a and 4b are plan and inlet feed end views of the apparatus of FIG. 3;

FIGS. 5a to 5c are perspective elevations of an in-feed conveyor, a container metering mechanism and a blade stop, respectively;

FIGS. 6a and 6b are perspective elevations of a transfer conveyor and indexing mechanism, respectively, of the lower assembly;

FIG. 7 is a perspective elevation of the upper assembly comprising a lid fold mechanism, a material web tucking mechanism, a web folding station and a compression mechanism;

FIGS. 8a and 8b are perspective elevation of a lid control guide and the lid fold mechanism, respectively;

FIGS. 9a and 9b are perspective elevations of the web tucking mechanism and a detail thereof, respectively;

FIGS. 10a to 10d are perspective, end, side and bottom plan views, respectively, of the web folding station;

FIG. 11 is a perspective elevation of a fixed paper folding mechanism of the material web folding station;

FIG. 12 is a perspective elevation of a moveable folding mechanism of the web folding station; and

FIG. 13 is a perspective elevation of the compression mechanism.

### DETAILED DESCRIPTION OF THE PREFERRED EMBODIMENT

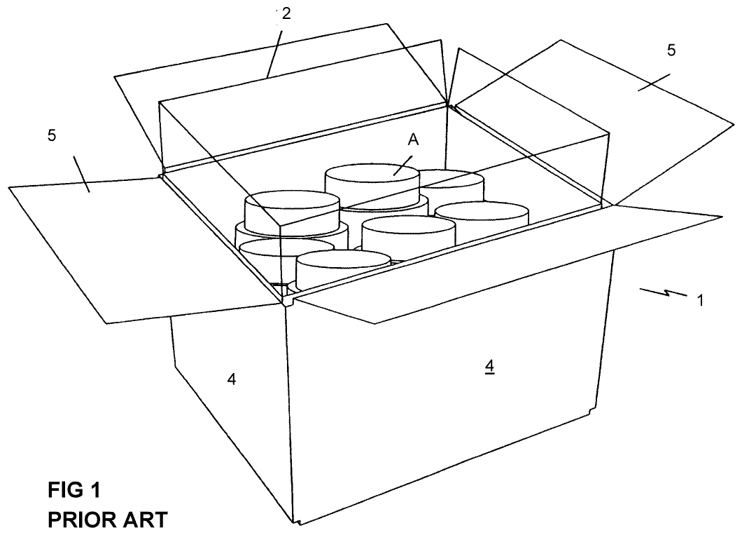

Referring to the drawings and initially to FIG. 1, a RSC type container 1 of the prior art normally formed from a blank cut from craft card or cardboard and includes a flexible card or paper web 2 which is secured by adhesive to side wall forming portions 4, the web overlying lid forming elements 5 of the container blank before it is erected to an open-mouthed configuration, as shown Articles A to be shipped are placed within the material web 2 which lines the container thus formed and has adhesive carrying surfaces adapted to adhere only to like surfaces. The web 2 is manually tensioned over the articles A and the web is “scrunched” to activate the adhesive on the adhesive carrying surfaces. The lid elements 5 are then closed and sealed to forma a shipping pack. It will be appreciated by the skilled addressee that although the container and method of forming a shipping pack is quick of great utility in low-volume packaging or in the shipping of bespoke or high-value items, neither the container nor the method lend themselves to high-volume scenarios where rapid automated throughput is required.

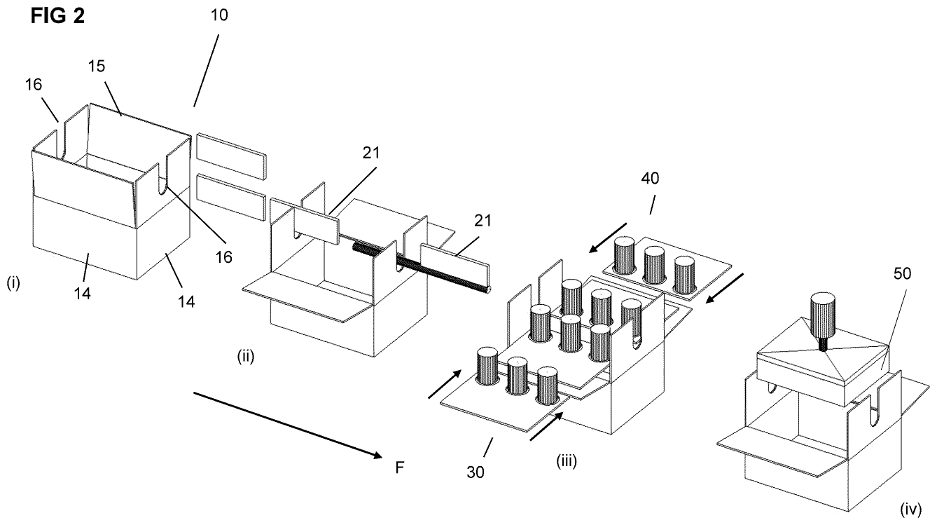

Referring now to FIG. 2 which is a schematic illustration of a container 10 being feed through a plurality of stations where successive steps of the method of securing articles within the container to form a shipping pack by means of the apparatus presented in more detail hereinbelow is shown. In FIG. 2, the material web has been removed for clarity. In the subsequent drawings, the container itself is removed for clarity so that the components of the apparatus for effecting the method of the invention and the actions performed may be more readily appreciated.

The container 10 and the blank from which it is formed comprise a series of four segments, each having a side wall portion 14 to which there is attached, along respective fold lines, a base element (not shown) and a lid element 15, the segments being joined to at least one other segment by a side wall fold line, in common with the container of the prior art, illustrated in FIG. 1.

The material web (not shown) which is adapted to line the container is secured to each side wall 14 adjacent the respective base element fold lines and is sufficient in height to align with or protrude from outer edges of the lid elements 14 when the container is in an open-mouthed-configuration.

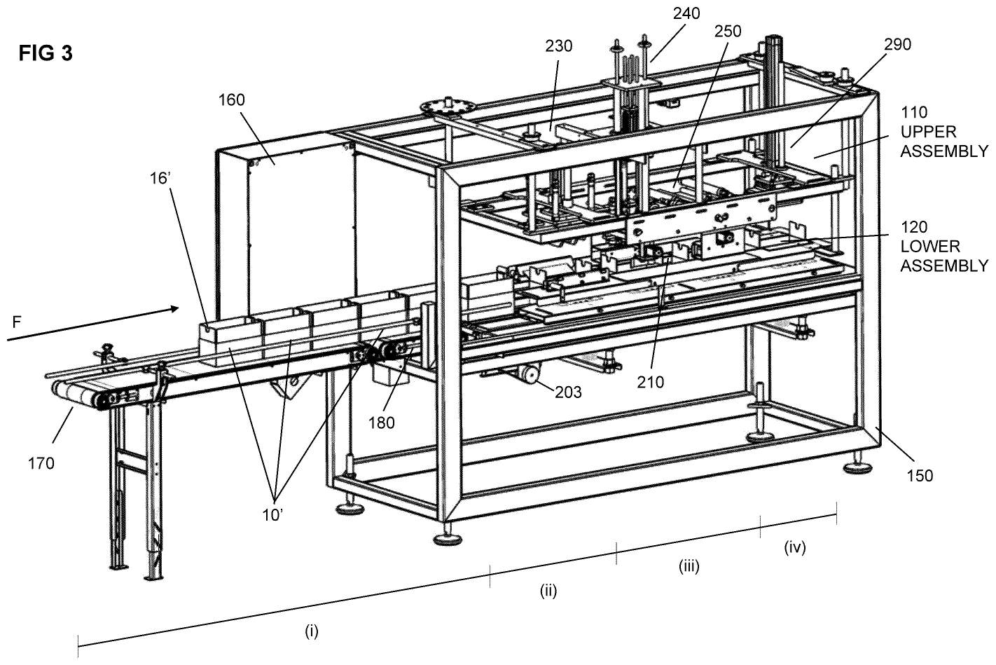

Two of the lid elements 15 have defined therein an access aperture 16 centrally disposed on and extending from the outer edge thereof towards its fold line. As shown in FIG. 2, the access aperture comprises a slot extending from the outer edge of the selected lid elements towards and, in one arrangement, at least one half way towards the lid element fold line. It will be noted that in FIG. 3, the access aperture comprises a semi-circular aperture cut from the outer edge of the selected lid elements 15.

The material web includes adhesive carrying portions which are adapted to adhere together when positioned to overlie one another and compacted to activate the pressure-sensitive adhesive thereon to engage intimately against the or each article to secure said article(s) therewithin.

FIG. 2 also schematically represents the primary stations of an apparatus for conforming a material web of a lined container as described hereinabove to retain articles within the container to form a shipping pack. The modified container is presented in an open-mouthed configuration within which one or more articles for shipping have been placed on the base thereof. The outer edges of the lid elements 15 are presented as pairs of parallel and perpendicular edges with respect to a throughflow direction F of the apparatus and are aligned with their respective side walls 14.

The apparatus comprises an upper assembly and a lower assembly each having components, as detailed below, which act upon the containers 10 which are presented at an inlet feed (i) from which filled lined containers are released in timed sequence along a conveyor.

At a first station (ii), downstream of the inlet feed (i), lid elements disposed parallel to the feed direction F are deflected outwardly and web folding fingers 21 penetrate the access apertures 16 of each lid element disposed perpendicularly to the feed direction, deflecting the material web inwardly over the or each article therewithin and conforming the material web in a predetermined folding pattern. As a result, portions of the material web corresponding to the outwardly deflected lid elements are angled inwardly.

At a second station (iii) positioned downstream in the feed direction F to which the container is conveyed, the outwardly deflected lid elements 15 are guided under retaining plates (not shown) over which sequentially a first side folding mechanism 30 and a second side folding mechanism 40 convey the exposed material web into a folded pattern over the or each article and optionally apply a minor tamping force to the folded web material.

Subsequently, the container is conveyed from said second station (iii) to a compression station (iv) where a conformable pad 50 penetrates the open-mouthed container and presses downwardly (with a force exceeding that of the tamping force) onto the folded material web to conform the material web intimately around the or each article and to activate the adhesive on the adhesive carrying portions of the web.

Finally, the open-mouthed container with secured articles therein is conveyed via an outlet to further apparatus or directly connected stations (not shown) for folding and sealing of the lid elements 15 to form a sealed shipping pack.

Again, with reference to FIG. 2, in accordance with the method of the invention, a lined container 10 within which one or more articles A have been placed is presented in an open-mouthed configuration at the inlet feed (i) of the apparatus of the invention.

As noted above, in the open-mouthed configuration of the container 10, the outer edges of the lid elements 15 are presented as pairs of parallel and perpendicular edges aligned with their respective side walls 14 and the opposed pair of access apertures 16 are aligned with the flow direction F.

Containers are released in timed sequence along a conveyor at the inlet feed towards a first station (ii) where lid elements disposed parallel to the feed direction F are deflected outwardly and brought into alignment with retaining plates of the second station (iii). Material folding fingers 21 penetrate the access apertures 16 of each lid element disposed perpendicularly to the feed direction to deflect inwardly portions of the material web over the or each article. As the fingers deflect the material web, it is conformed in a predetermined folding pattern whereby portions of the material web corresponding to the deflected lid elements are angled inwardly.

At the second station (iii), the outwardly deflected lid elements are guided under the retaining plates over which sequentially the first side folding mechanism 30 and the second folding mechanism 40 convey the exposed material web into a folded pattern over the or each article and optionally apply a minor tamping force to the folded web material.

The container is conveyed from said second station (iii) downstream in the feed direction F to the compression station (iv) where the conformable pad 50 is lowered from the upper assembly and into the open-mouth of the container and is pressed downwardly onto the folded material web to conform the material web intimately around the or each article and to activate the adhesive on the adhesive carrying portions of the web so as to retain the or each article within the container. This action secures the articles to the base of the lined container. Thereafter, with secured articles therein, the open-mouthed container is conveyed via an outlet to further apparatus or directly connected stations for folding and sealing of the lid elements to form a sealed shipping pack.

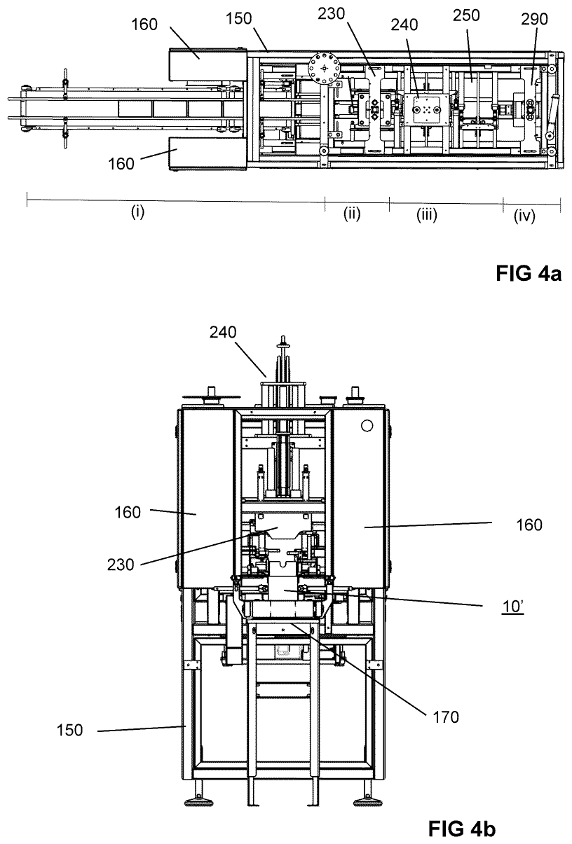

FIGS. 3, 4a and 4b show in more detail an apparatus in accordance with the invention and includes each of the stations (i), (ii), (ii), (iv) referenced in FIG. 2. More particularly, the assembly comprises upper 110 and lower 120 assemblies, the upper assembly 110 being height-adjustable with respect to the lower assembly 120 so as to accommodate runs of containers of alternative predetermined height profiles. The upper and lower assemblies are mounted within a support framework 150 which carries control interface enclosures 160 (one of which being removed from FIG. 3 for clarity).

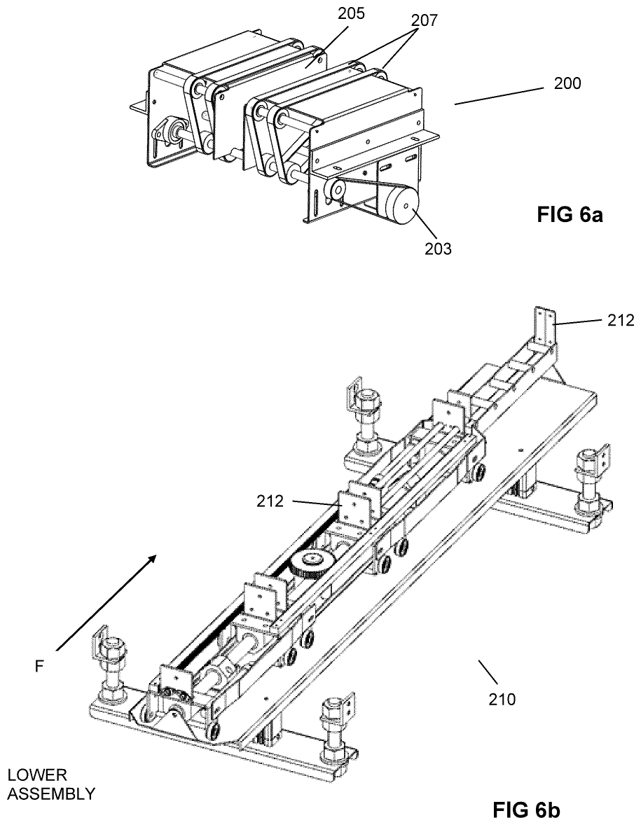

At the inlet feed (i), a second construction of container 10′ having a less pronounced access aperture 16′, comprising a semi-circular cutout from the outer edges of the lid elements presented perpendicular to the flow direction F, there is accumulated a number of containers for timed release to the first lid folding station (ii) via a conveyor 200 which will be described in more detail with respect to FIG. 6a.

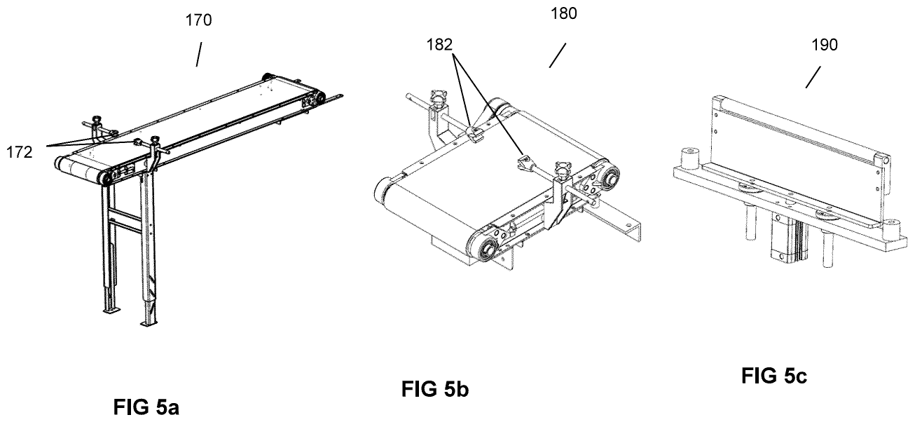

FIGS. 5a to 5c show the major components of the inlet feed (i) which comprises an in-feed conveyor 170, a container metering mechanism 180 and a blade stop 190. The in-feed conveyor carries the containers towards the framed part of the apparatus and serves as a storage buffer. The container metering mechanism 180 comprises a marshalling conveyor for timed release of the containers. Both the infeed and marshalling conveyors include guard rails retained in position by guard rails holders 172, 182 which ensure the containers 10′ maintain their introduced orientation. The blade stop 190 works in conjunction with the marshalling conveyor 180 to control the infeed back-pressure and meter the containers into the control region between the upper and lower assemblies.

FIGS. 6a and 6b show the major components of the lower assembly 120 comprising the transfer conveyor 200 and an indexing mechanism 210, respectively. The transfer conveyor 200 positions the containers to be received by the indexing mechanism via belts 202 driven via drive motor 203. The belts are disposed either side of a central slot 205 into which the indexing mechanism 210 rises from beneath to engage the metered containers.

The indexing mechanism has four sets of clamps 212 presenting clamping positions and allows the indexing mechanism to rise for its lower position to align with the transfer conveyor with the clamps open. The clamps then close to hold the containers which are subsequently moved in the downstream direction F. Container side clamps engage the side walls 14 whereafter the clamps 212 disengage and the indexing mechanism drops to its lower position and moves upstream ready for the next cycle.

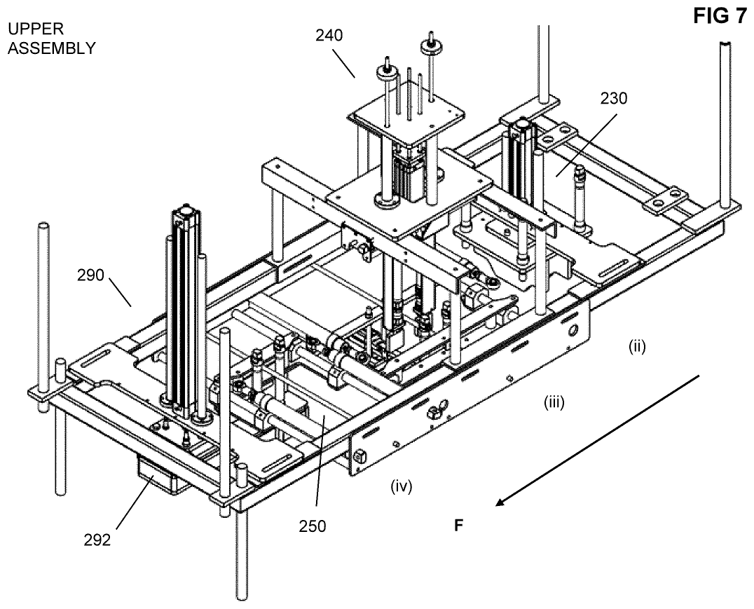

FIG. 7 shows the complete upper assembly 110 comprising a lid fold mechanism, 230, a material web tucking mechanism 240, a web folding station 250 and a compression mechanism 290.

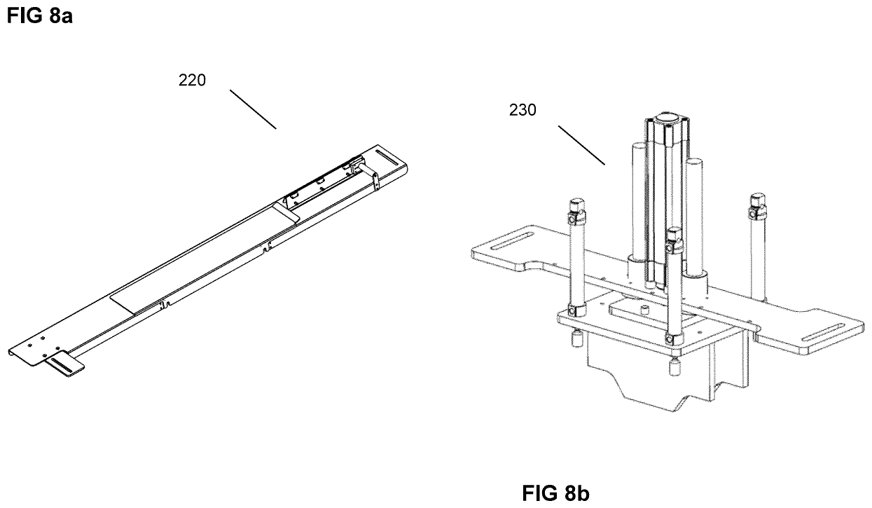

The upper assembly 110 is mounted on a sub frame which winds up and down to suit the height of the container being processed. The lid control guides 220, of which one is shown in FIG. 8a, are attached to this assembly and are set so the side lids can fold outwards to the horizontal position with the container remaining on the bed of the machine. The control guides 220 capture the side lid elements and include a side guide for the containers travelling through the apparatus.

The lid fold mechanism 230 of FIG. 8b folds the side lids down to the horizontal position for travelling through the machine while leaving both the access aperture carrying lids and the material web upright.

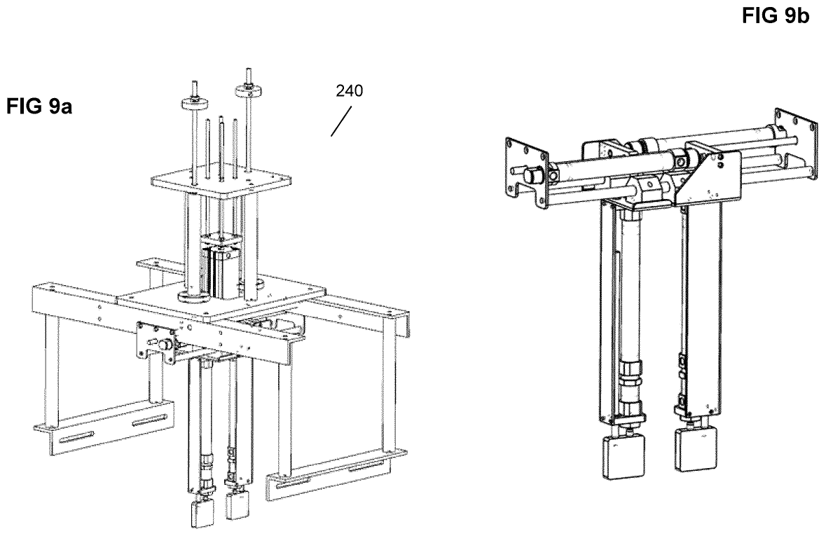

The web tucking mechanism 240 shown in FIGS. 9a and 9b perform the start of the material web folding process by moving down to a position determined by the depth of the access aperture slot 16,16′ (selected before a run by manual adjustment in absence of predetermined levels) in the upright lid, moves into the open mouth of the container and pushes the web down to a product level where the articles to be shipped are encountered to achieve the first part of the folding.

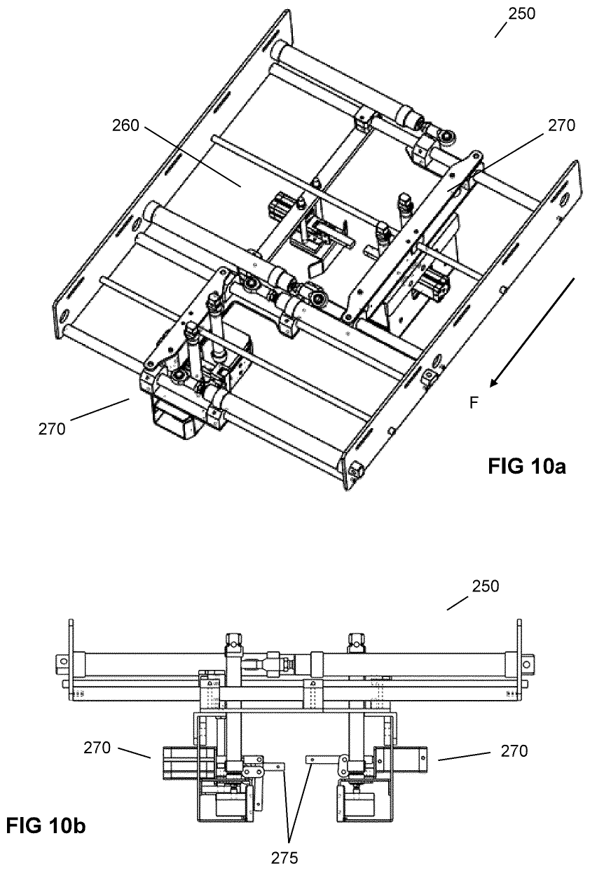

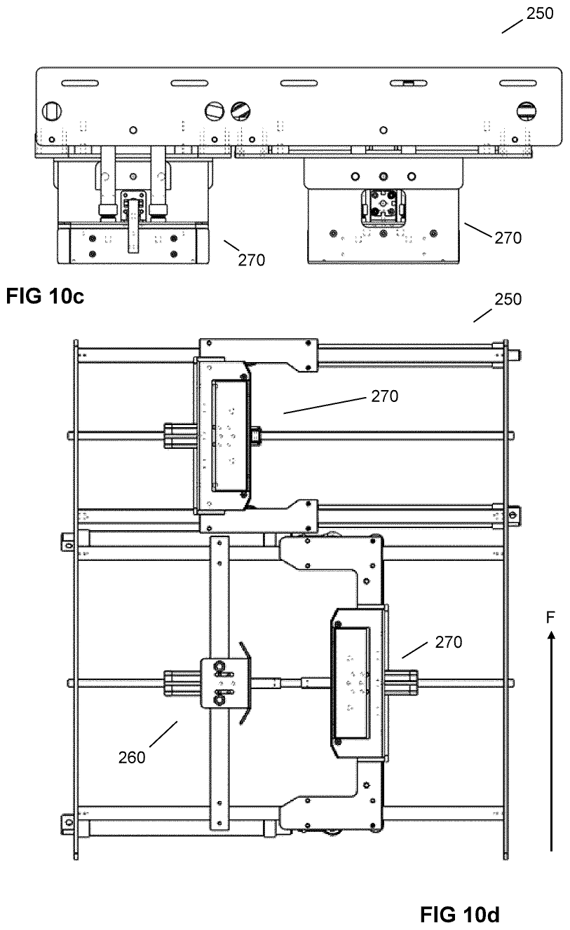

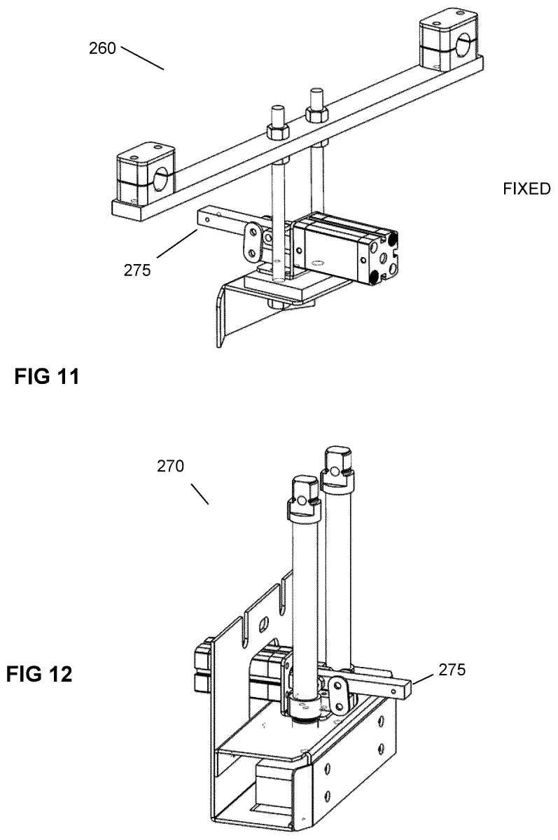

FIGS. 10a to 10d are views of the complete web folding station 250 within which there are provided a fixed folding mechanism 260 of FIG. 11 and a pair of laterally moveable mechanisms 270 of FIG. 12 each which engage the web in sequential folding strokes via respective actuator arms 275.

The first folding mechanism 260 holds the first selected side presented web surface while tucking takes place after which the opposite side web.

With the moveable folding mechanisms, a first side of the web is held while the side web tucking takes place. During this interval, while the first side web is being folded, it is allowed by virtue of a soft face of the clamp to be gradually released from the clamp while the folding motion is happening.

Subsequently, the opposite side web is held to allow it to be folded over the articles to be retained and is again gradually released during the motion via a soft face clamp.

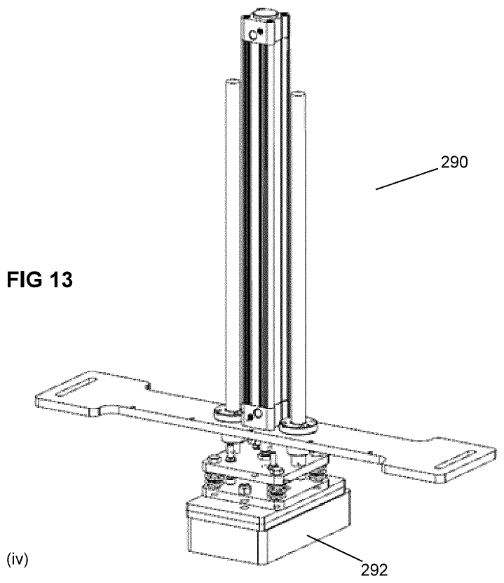

Finally, as shown in FIG. 13, the compression mechanism carries a compression plate having a soft sponge-like pad into engagement with the folded web to compress the web into intimate conforming contact with the articles therein and activating the adhesive on the adhesive carrying portions of the material web, thereby securing the articles.

It will of course be understood that the invention is not limited to the specific details described herein, which are given by way of example only, and that various modifications and alterations are possible within the scope of the appended claims.

1. A container lined with a material web, the container comprising:
a series of four segments, each having a side wall portion to which there is attached, along respective fold lines, a base element and a lid element, the segments being joined to at least one other segment by a side wall fold line,
the material web adapted to line the container being secured to each side wall adjacent the respective base element fold lines and being sufficient in height to align with or protrude from outer edges of the lid elements when the container is in an open-mouthed-configuration,
in which at least two lid elements have defined therein an access aperture centrally disposed on and extending from the outer edge thereof towards its fold line,
whereby adhesive carrying portions of the material web are engaged to overlie one another and compacted to adhere to one another intimately against the or each article to secure said articles therewithin.

2. A container as claimed in claim 1, in which the access aperture is defined by a semi-circular aperture cut from the outer edge of the selected lid elements.

3. A container as claimed in claim 1, in which the access aperture is defined by a slot extending from the outer edge of the selected lid elements at least one half way towards the lid element fold line.

4. A container blank for forming a container as claimed in claim 1, in which the container blank comprises a series of four segments, each having a side wall portion to which there is attached, along respective fold lines, a base element and a lid element, the segments being joined to at least one other segment by a side wall fold line wherein a material web extends over at least a part of each of the segments and defines the inner surface of the container formed from the blank.

5. A method of conforming a material web of a lined container of the type claimed in claim 1 to retain an article within the container to form a shipping pack, the container being presented in an open-mouthed configuration within which one or more articles for shipping have been placed on the base thereof, the outer edges of the lid elements being presented as pairs of parallel and perpendicular edges aligned with their respective side walls, the method comprising:
releasing in timed sequence along a conveyor at an inlet feed, defining a feed direction, filled lined containers;
at a first folding station deflecting outwardly lid elements disposed parallel to the feed direction, penetrating the access apertures of each lid element disposed perpendicularly to the feed direction with material folding fingers to deflect inwardly the material web over the or each article.

6. A method as claimed in claim 5 which includes conforming the material web in a predetermined folding pattern whereby portions of the material web corresponding to the deflected lid elements are angled inwardly.

7. A method as claimed in claim 5 wherein, at a second folding station positioned downstream in the feed direction to which the container is conveyed, the outwardly deflected lid elements are guided under retaining plates.

8. A method as claimed in claim 7, in which over said retaining plates sequentially a first side folding mechanism and a second folding mechanism convey the exposed material web into a folded pattern over the or each article.

9. A method as claimed in claim 8 which includes applying a minor tamping force to the folded web material.

10. A method as claimed in claim 7, in which, at a compression station to which the container is conveyed from said second station, a conformable pad penetrates the open-mouthed container and is pressed downwardly onto the web material.

11. A method as claimed in claim 10, in which the conformable pad is pressed downwardly with a force exceeding that of a tamping force applied to the folded web material at the second folding station.

12. A method as claimed in claim 10, in which the conformable pad is pressed downwardly onto the material web to conform the material web intimately around the or each article.

13. A method as claimed in claim 12, in which the adhesive on the adhesive carrying portions of the web is activated by pressure applied by the conformable pad so as to retain the or each article within the container.

14. A method as claimed in claim 5, in which the open-mouthed container with secured articles therein is conveyed via an outlet to further apparatus or directly connected stations for folding and sealing of the lid elements to form a sealed shipping pack.
